(19) United States
(12) Patent Application Publication
(10) Pub. No.: US 2015/0189384 A1
(43) Pub. Date: Jul. 2, 2015

(54) PRESENTING INFORMATION BASED ON A VIDEO

(71) Applicant: Alibaba Group Holding Limited, George Town (KY)

(72) Inventors: Wuping Du, Hangzhou (CN); Kunyong Cao, Hangzhou (CN)

(21) Appl. No.: 14/570,604

(22) Filed: Dec. 15, 2014

(30) Foreign Application Priority Data
Dec. 27, 2013 (CN) 201310741071.2

(51) Int. Cl. H04N 21/4725; H04N 21/8545; H04N 21/41; H04N 21/478; H04N 21/44; H04N 21/858; H04N 21/81

(52) U.S. Cl. CPC H04N 21/4725; H04N 21/8583; H04N 21/8545; H04N 21/8133; H04N 21/8186; H04N 21/47815; H04N 21/44008; H04N 21/4126

(57) ABSTRACT

Presenting information based on a video is disclosed, including: extracting a set of feature information from one or more images associated with a currently playing video; determining that the set of feature information matches a set of video feature information stored at a video database, wherein the set of video feature information corresponds to a set of identifying information associated with a video; generating a prompt based at least in part on the set of identifying information associated with the video that corresponds to the set of video feature information stored at the video database; presenting the prompt; and in response to a selection associated with the prompt to receive more information, performing a search at an information database based at least in part on the set of identifying information associated with the video.

### CROSS REFERENCE TO OTHER APPLICATIONS

This application claims priority to People's Republic of China Patent Application No. 201310741071.2 entitled A DATA PROCESSING METHOD FOR SMART TELEVISION, A SMART TELEVISION, AND A SMART TELEVISION SYSTEM, filed Dec. 27, 2013 which is incorporated herein by reference for all purposes.

### FIELD OF THE INVENTION

The present application relates to smart television technology. More specifically, the present application relates to presenting information based on a video playing at a smart television.

### BACKGROUND OF THE INVENTION

As technology improves, smart television sets are being designed with greater capabilities. In addition to having traditional video and gaming features, smart televisions are configured to have Internet features and are also sometimes capable of cross-platform searches between a television, the Internet, and computer programs. Users can now access information they need via a smart television.

Conventionally, if a smart television is playing a program of interest to a user and the user wishes to learn more about the program, he or she would generally need to use a separate device, such as a mobile phone, to perform searches regarding the program on the Internet. In other words, the conventional smart television is still unable to facilitate a user in searching for more information related to the content playing at the television. For example, generally, the conventional smart television is unable to generate prompts in real-time for a user and/or provide recommendation information relating to the content that is currently playing at the television, yet this information may be precisely the information that the user is interested in.

### BRIEF DESCRIPTION OF THE DRAWINGS

Various embodiments of the invention are disclosed in the following detailed description and the accompanying drawings.

FIG. 1 is a diagram showing an embodiment of a system for presenting information based on a video.

FIG. 2 is a flow diagram showing an embodiment of a process for presenting information based on a video.

FIG. 3 is a flow diagram showing an example of a process for presenting information based on a video.

FIG. 4 is a flow diagram showing an example of a process for presenting information based on a video.

FIG. 5 is a flow diagram showing an example of a process for presenting information based on a video.

FIG. 6 is a diagram showing an embodiment of a system for presenting information based on a video.

FIG. 7 is a diagram showing an embodiment of a system for presenting information based on a video.

FIG. 8 is a diagram showing an embodiment of a system for presenting information based on a video.

FIG. 9 is a functional diagram illustrating an embodiment of a programmed computer system for implementing presenting information based on a video.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of presenting information based on a video are described herein. In various embodiments, a video is currently playing at a smart television. In various embodiments, a “smart television” comprises a television set that is configured to communicate over a network (e.g., the Internet). A set of feature information is extracted from one or more images associated with the currently playing video. The set of feature information is determined to match a set of video feature information stored at a video database. The set of video feature information corresponds to a set of identifying information associated with a video. A prompt is generated based at least in part on the set of identifying information associated with the video that corresponds to the set of video feature information stored at the video database. The prompt is presented. In response to the selection associated with the prompt to receive more information, a search is performed at an information database based at least in part on the set of identifying information associated with the video. For example, the search results may comprise merchandise information, such as product information.

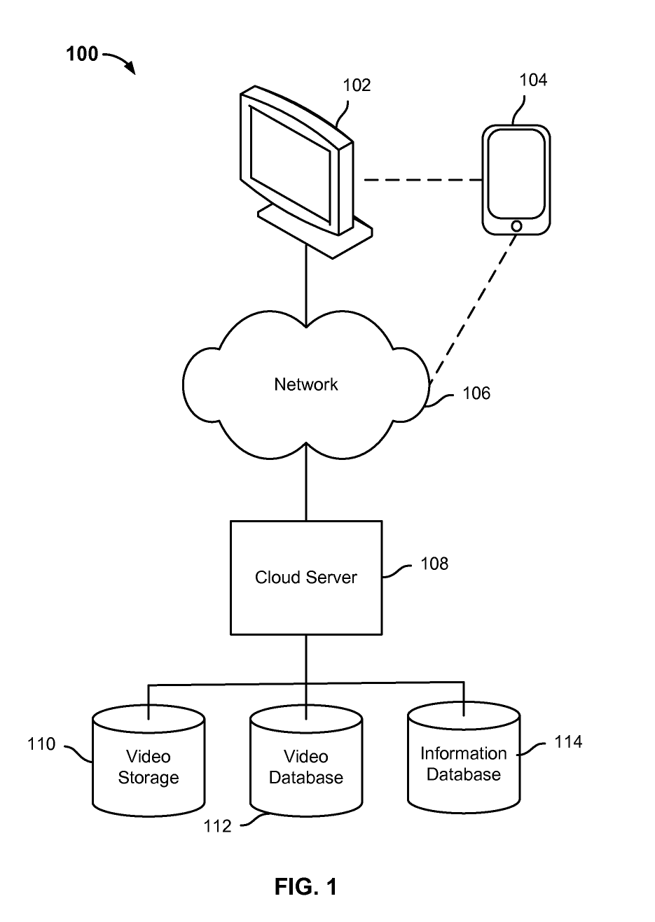

FIG. 1 is a diagram showing an embodiment of a system for presenting information based on a video. In the example, system 100 includes smart television 102, device 104, network 106, and cloud server 108. Network 106 includes one or more of high-speed data networks and/or telecommunications networks. Cloud server 108 is configured to access video storage 110, video database 112, and information database 114. In some embodiments, video storage 110, video database 112, and information database 114 may be configured as one or more storages.

Smart television 102 is configured to communicate to other entities over network 106. In various embodiments, a video is currently playing at smart television 102. For example, the video playing at smart television 102 is also stored at video storage 110. Smart television 102 is configured to enable more information to be provided based on the content of the video by first capturing one or more frames of the video and then extracting a set of feature information from the captured video frames. The set of feature information comprises values corresponding to predetermined features or attributes of the video frames. In some embodiments, smart television 102 is configured to query cloud server 108 to compare the set of feature information to sets of video feature information stored at video database 112. For example, each set of video feature information stored at video database 112 corresponds to a video storage stored at video storage 110. In the event that there is a set of video feature information stored at video database 112 that matches the set of feature information, then smart television 102 is configured to generate a prompt determined based on a set of identifying information corresponding to the matching set of video feature information. The set of identifying information corresponding to the matching set of video feature information is also stored at video database 112 and is configured to include information that corresponds to the video stored at video storage 110 from which the matching set of video feature information was extracted.

As will be described in further detail below, a user may use device 104 to interact with the prompt displayed at smart television 102 in various manners. In some embodiments, device 104 comprises a remote control device that is configured to transmit data to smart television 102 and may or may not be configured to also communicate over network 106. In some embodiments, device 104 comprises a mobile device that includes a camera function and is also configured to communicate over network 106. For example, a user may use device 104 to communicate to smart television 102 by inputting data at device 104 to cause device 104 to send a response associated with the prompt displayed at smart television 102, which will cause smart television 102 to query cloud server 108 to perform a search based on the set of identifying information stored at information database 114. In some embodiments, information database 114 stores (e.g., merchandise) information that corresponds to each video stored at video storage 110. The search result can then be displayed at smart television 102. In another example, a user may use device 104 to capture (e.g., take a photo of) the prompt displayed at smart television 102 to obtain the set of identifying information. Device 104 may proceed to query cloud server 108 to perform a search based on the set of identifying information stored at information database 114. The search result can then be displayed at device 104.

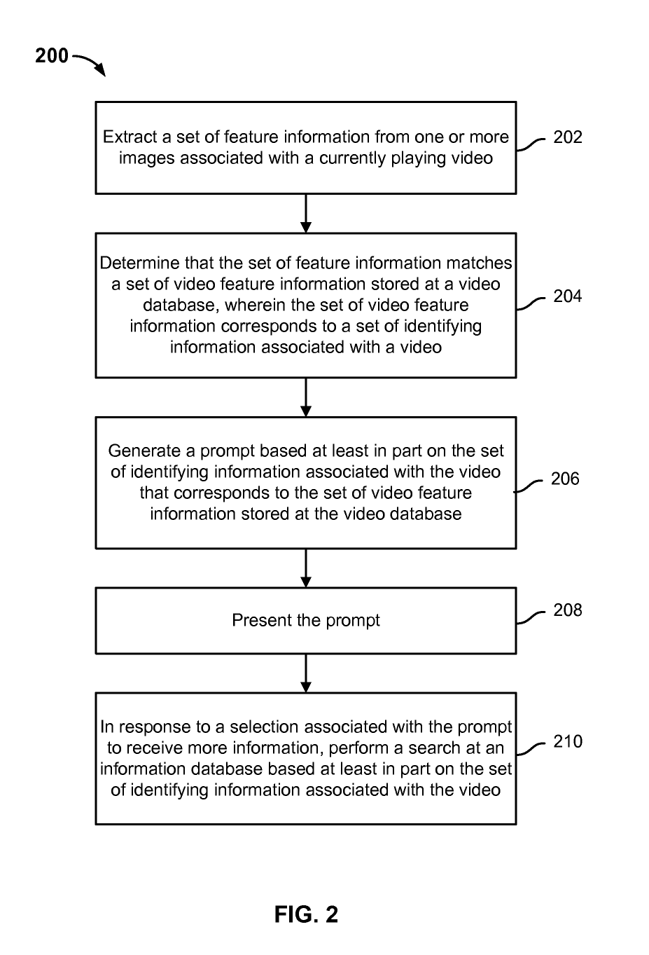

FIG. 2 is a flow diagram showing an embodiment of a process for presenting information based on a video. In some embodiments, process 200 is implemented at system 100 of FIG. 1.

At 202, a set of feature information is extracted from one or more images associated with a currently playing video.

One or more frames or images from a video that is currently playing are extracted. In various embodiments, the video is currently playing at a smart television. For example, the video frames are captured through a (e.g., high-definition) video capturing card. In some embodiments, the captured video frames are pre-processed before feature values are extracted from them. For example, the captured video frames may be resized and/or cropped during pre-processing.

Generally, feature extraction is a technique that maps input information to a reduced set of information (i.e., features, which can be represented by mathematical vectors, for example) such that the input information can be accurately recognized or classified based on the reduced representation of features. A feature is a variable that is used to represent a characteristic of the input information. Features are selected and defined by designers of a feature extraction and are processed to help decode/classify the input information, distinguish/disambiguate the input information, and/or accurately map the input information to the output values. As applied to the present application, feature extraction is used to extract information from the one or more frames captured from a currently playing video that can be used to identify the video frames and/or the video itself. In various embodiments, a set of features is predetermined. In some embodiments, the predetermined set of features includes visual information, audio information, or a combination of visual and audio information. For example, the set of features may include one or more of the following: color features, position features, binary image features, speeded up robust features (SURF), and audio features. A set of feature information (e.g., values) corresponding to the predetermined set of features is extracted from the one or more frames captured from the currently playing video. Any type of appropriate feature extraction technique may be used to extract the feature values.

In some embodiments, the feature extraction of step 202 is triggered by an event. For example, the video being paused may be an event that triggers features to be extracted from the frame on which the video was paused. In another example, the start of playing back an advertisement video may be an event that triggers features to be extracted from the currently playing advertisement video. In some embodiments, the feature extraction of step 202 is performed periodically (e.g., every 15 minutes of video playback).

As mentioned above, the set of feature information extracted from the one or more frames is feature information that can be used to identify the video frames. The set of feature information is used to determine whether the one or more frames are from a video that is stored at a video storage. For example, the video storage may comprise a storage for advertisement videos.

At 204, the set of feature information is determined to match a set of video feature information stored at a video database, wherein the set of video feature information corresponds to a set of identifying information associated with a video.

A video database is maintained. The video database stores a set of video feature information extracted from, and therefore corresponding to, each video stored in a video storage. In some embodiments, the video storage is also maintained. The video storage includes various video files from which features have been extracted and added to the video database. For example, the video files of the video storage may be provided by one or more content providers. In some embodiments, the set of video feature information corresponding to each video includes feature values corresponding to at least some of the same predetermined set of features that were extracted from the video frames of step 202. In some embodiments, the set of video feature information corresponding to each video includes feature information extracted from a potentially larger number of video frames than the number of frames from which feature information was extracted in step 202. In some embodiments, the video database is configured in a cloud server.

In addition to the set of video feature information corresponding to each video in the video storage, a set of identifying information corresponding to the video may be stored as well in the video database. For example, the set of identifying information corresponding to each video may include keywords that are associated with the video, the title/name of the video, and/or other metadata associated with the video.

In various embodiments, an information database is also maintained. The information database stores at least a set of information corresponding to each video stored in the video storage.

In some embodiments, at least one of the video storage, the video database, and the information database is associated with a cloud server.

Table 1, below, is an example of the type of content that is stored at each of a video storage, a video database, and an information database.

TABLE 1

| Video | | | Information |
|---|---|---|---|
| Storage | Video Database | | Database |
| Video file | Set of video feature | Set of identifying | Set of information |
| | information | information | |

As shown in Table 1, above, the video storage stores video files, the video database stores a set of video feature information and a set of identifying information corresponding to each video file in the video storage, and the information database stores a set of information corresponding to each video file in the video storage.

In some embodiments, the video storage comprises an advertising video storage that stores advertising videos. In some embodiments, the video database comprises an advertising video database that stores a set of video feature information that is extracted from each corresponding advertisement video from the video storage and also a set of identifying information corresponding to that advertisement video from the video storage. In some embodiments, the information database comprises an advertising information database that stores a set of merchandise information that corresponds to each corresponding advertisement video from the video storage. For example, the set of merchandise information may include information associated with products and/or links to webpages associated with products that are related to the content of the corresponding video.

Table 2, below, is an example of the type of content that is stored at each of an advertising video storage, an advertising video database, and an advertising information database.

TABLE 2

| Advertising | | | Advertising |
|---|---|---|---|
| Video | Advertising Video | | Information |
| Storage | Database | | Database |
| Advertising | Set of video feature | Set of identifying | Set of |
| video | information | information | merchandise |
| file | | | information |

As shown in Table 2, above, the advertising video storage stores advertising video files, the advertising video database stores a set of video feature information and a set of identifying information corresponding to each advertising video file in the advertising video storage, and the advertising information database stores a set of merchandise information corresponding to each advertising video file in the advertising video storage.

The set of feature information extracted from the video frames is compared against the sets of video feature information that are stored at the video database (e.g., the advertising video database). It is determined whether the set of feature information extracted from the video frames matches a set of video feature information that is stored at the video database. In some embodiments, the set of feature information extracted from the video frames can be matched to a set of video feature information that is stored at the video database through either fuzzy matching or exact matching. In the event that the set of feature information extracted from the video frames is found to match a set of video feature information that is stored at the video database, then the set of identifying information associated with the matching set of video feature information is obtained from the video database. As described above, each set of video feature information that is stored at the video database corresponds to a video file stored at the video storage and also a set of identifying information corresponding to that same video file. In some embodiments, the set of identifying information identifies the video that is currently playing.

In the event that the set of feature information extracted from the video frames is found to not match a set of video feature information that is stored at the video database, then process 200 ends.

At 206, a prompt is generated based at least in part on the set of identifying information associated with the video that corresponds to the set of video feature information stored at the video database.

A prompt is generated based on the set of identifying information from the video database corresponding to the matching set of video feature information. In some embodiments, the prompt includes the set of identifying information associated with the video. The prompt may include text and/or images, for example. In some embodiments, the prompt may include text that asks a user whether he or she would like to receive further information associated with the video that is currently playing and/or the set of identifying information. In some embodiments, the prompt includes at least a first control that the user may select to receive further information. In some embodiments, the prompt includes a second control that the user may select to dismiss the prompt. In some embodiments, the prompt does not include a control and comprises a code (e.g., a Quick Response (QR) code) that is configured with information associated with the set of identifying information associated with the video.

At 208, the prompt is presented.

In some embodiments, the prompt may be displayed at the same screen at which the video is currently playing. In various embodiments, the prompt is displayed at the smart television. In some embodiments, the prompt may be displayed at a different screen than the screen at which the video is currently playing.

At 210, in response to a selection associated with the prompt to receive more information, a search is performed at an information database based at least in part on the set of identifying information associated with the video.

In the event that the user makes a selection with respect to the prompt that indicates that he or she would like to receive more information, a search is performed at the information database based at least in part on the set of identifying information associated with the video. In some embodiments, the information database comprises a merchandise information database and a set of merchandise information is found based on the set of identifying information associated with the video.

In the event that the user does not make a selection with respect to the prompt that indicates that he or she would like to receive more information (e.g., the user makes a selection to dismiss the prompt), process 200 ends.

In some embodiments, a selection associated with the prompt to receive more information is performed using a device. For example, the prompt may be displayed at a smart television display and the selection may be made by a user using a remote device and/or a mobile device.

In some embodiments, the results of the search based on the set of identifying information associated with the video are presented. In some embodiments, the search results are displayed at the same screen at which the video is currently playing. In some embodiments, the search results may be displayed at a different screen than the screen at which the video is currently playing.

For example, an advertising video may be currently playing at a smart television. One or more frames of the currently playing advertising video are captured and a set of feature information is extracted from the video frames by the smart television. If it is determined that the set of feature information associated with the video frames matches a set of video feature information stored at an advertising video database, then the set of identifying information associated with the corresponding advertising video file is obtained from the advertising video database. A prompt can be generated based on the set of identifying information and displayed at the smart television screen. For example, the prompt includes a control (e.g., button) that a user can select to receive more information. In some embodiments, the user may respond to this prompt by selecting the button that is associated with the prompt using a remote control device that is configured to transmit information to the smart television. In response to the user's selection of the button, for example, the smart television will search for the advertising information database corresponding to the set of identifying information in an advertising information database and display the search results at the display screen of the smart television. For example, each search result may correspond to a product that matches the set of identifying information associated with the video. In some embodiments, the user may continue to engage in data exchange with the smart television using the remote control device and may even purchase a displayed product. For example, the user may scroll through the search results that are presented at the display screen of the television by using the (e.g., hard) buttons of the remote control device. The user may be prompted by the smart television to log into his or account at a shopping platform associated with at least some products of the presented search results. After the user has logged into his or her account associated with the shopping platform, in some embodiments, the user may select one or more search results presented at the smart television via the remote control device to add the products associated with the search results into a shopping cart associated with the user's account at the shopping platform. The user may follow through with purchasing the products in the shopping cart associated with his or her account at the shopping platform at a later time (e.g., using a mobile device or desktop device). After the user has logged into his or her account associated with the shopping platform, in some embodiments, the user may select one or more search results presented at the smart television via the remote control device to directly purchase the products associated with the search results. The user may directly purchase the products by inputting his or her credit card information through one or more purchase interfaces presented at the smart television using the remote control device.

In some embodiments, the user may respond to this prompt by using a mobile device to capture the information associated with the prompt information. For example, prompt information can be displayed in the form of a QR code and the user may select the prompt by scanning the QR code with a mobile device with a scanning or camera function. In response to scanning this QR code, an application executing at the mobile device that is configured to read QR codes may use the content of the QR code (the set of identifying information associated with the video) to perform a search at the advertising information database and display search results at the display screen of the mobile device. The user may select a search result that is displayed at the display screen of the mobile device via a touchscreen or other input mechanism of the mobile device. The user may be prompted by the smart television to log into his or account at a shopping platform associated with at least some products of the presented search results. After the user has logged into his or her account associated with the shopping platform, in some embodiments, the user may select one or more search results presented at the mobile device via an input mechanism of the mobile device to add the products associated with the search results into a shopping cart associated with the user's account at the shopping platform. The user may follow through with purchasing the products in the shopping cart associated with his or her account at the shopping platform at a later time (e.g., using the mobile device or desktop device). After the user has logged into his or her account associated with the shopping platform, in some embodiments, the user may select one or more search results presented at the mobile device via an input mechanism of the mobile device to directly purchase the products associated with the search results. The user may directly purchase the products by inputting his or her credit card information through one or more purchase interfaces presented at the mobile device. After the user has logged into his or her account associated with the shopping platform, in some embodiments, the user may select one or more search results presented at the mobile device via an input mechanism of the mobile device to view additional information associated with the products associated with the search results.

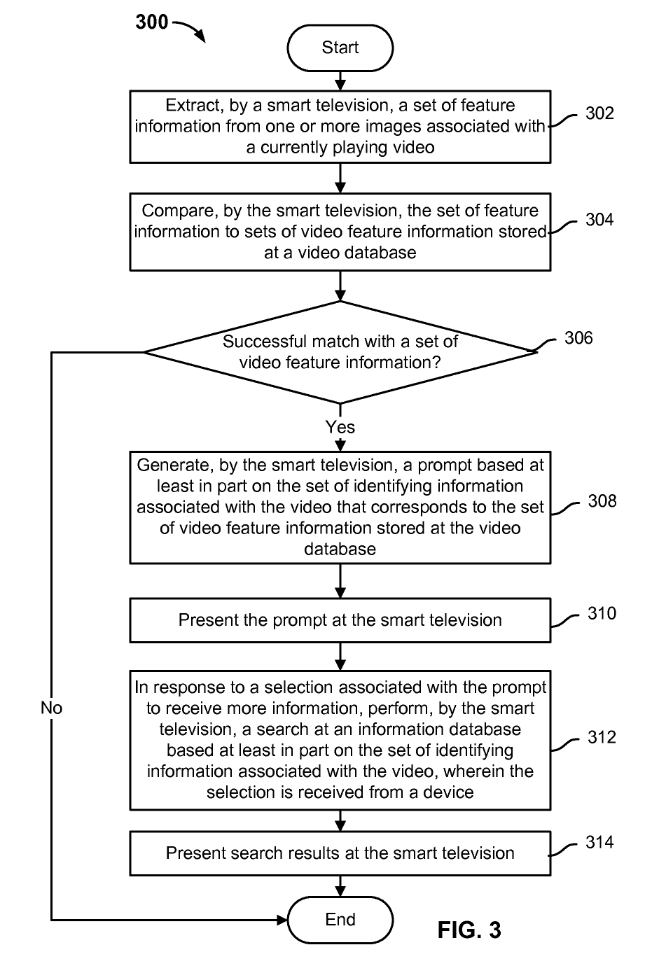

FIGS. 3, 4, and 5, below, each describes a different example process in which process 200 of FIG. 2 can be implemented by one or both of a smart television and a separate device (e.g., a remote television control or a mobile device).

FIG. 3 is a flow diagram showing an example of a process for presenting information based on a video. In some embodiments, process 300 is implemented at system 100 of FIG. 1. In some embodiments, process 200 of FIG. 2 is implemented at least in part by process 300.

Process 300 is implemented by a smart television such as smart television 102 of system 100 of FIG. 1.

At 302, a set of feature information is extracted by a smart television from one or more images associated with a currently playing video.

In various embodiments, the video is currently playing at the smart television.

At 304, the set of feature information is compared by the smart television to sets of video feature information stored at a video database.

The set of feature information that is extracted from the video frames is compared to the sets of video feature information stored at a video database. It is determined whether the set of feature information matches any set of video feature information that is stored at the video database. In some embodiments, the video database is associated with a cloud server.

At 306, it is determined by the smart television whether the set of feature information has successfully matched a set of video feature information stored at the video database, wherein the set of video feature information corresponds to a set of identifying information associated with a video. In the event that a set of video feature information stored at the video database has been determined to successfully match the set of feature information extracted from the video frames, control is transferred to 308. Otherwise, in the event that a set of video feature information stored at the video database has not been determined to successfully match the set of feature information extracted from the video frames, process 300 ends.

At 308, a prompt is generated by the smart television based at least in part on the set of identifying information associated with the video that corresponds to the set of video feature information stored at the video database.

For example, the prompt is displayed on the smart television. The prompt can appear in the form of text, numbers, pictures, or a combination thereof on the smart television screen.

At 310, the prompt is displayed at the smart television.

After the user observes the prompt, he or she may send a response by interacting with a device that is separate from the smart television. In process 300, the device may comprise a remote control device that is configured to transmit data to the smart television. For example, a user may make a selection associated with (e.g., a control displayed in) the prompt that is displayed at the smart television screen by pressing a button on the remote control device.

At 312, in response to a selection associated with the prompt to receive more information, a search is performed by the smart television at an information database based at least in part on the set of identifying information associated with the video, wherein the selection is received from a device.

In some embodiments, the information database is associated with a cloud server.

At 314, search results are displayed at the smart television.

For example, the smart television displays the search results on its screen, which may comprise merchandise information that is determined to relate to the set of identifying information associated with the currently playing video. If the user is interested in the displayed merchandise information, he or she may use the remote control device to further interact with the merchandise information, such as by requesting more information on a product, purchasing a product, and/or adding a product to a shopping cart. In some embodiments, after the smart television displays the search results at the display screen of the smart television, the user may interact with the search results and select one or more search results by transmitting information to the smart television via the remote control device. For example, the user may scroll through the search results that are presented at the display screen of the television by using the (e.g., hard) buttons of the remote control device. In some embodiments, prior to or subsequent to a user selecting a search result that is presented at the smart television, the user is prompted by a login screen displayed at the smart television to log into his or her account associated with a shopping platform associated with selling at least some of the products among the presented search results. After the user has logged into his or her account associated with the shopping platform, in some embodiments, the user may select one or more search results presented at the smart television via the remote control device to add the products associated with the search results into a shopping cart associated with the user's account at the shopping platform. The user may follow through with purchasing the products in the shopping cart associated with his or her account at the shopping platform at a later time (e.g., using a mobile device or desktop device). After the user has logged into his or her account associated with the shopping platform, in some embodiments, the user may select one or more search results presented at the smart television via the remote control device to directly purchase the products associated with the search results. The user may directly purchase the products by inputting his or her credit card information through one or more purchase interfaces presented at the smart television using the remote control device. After the user has logged into his or her account associated with the shopping platform, in some embodiments, the user may select one or more search results presented at the smart television via the remote control device to view additional information associated with the products associated with the search results.

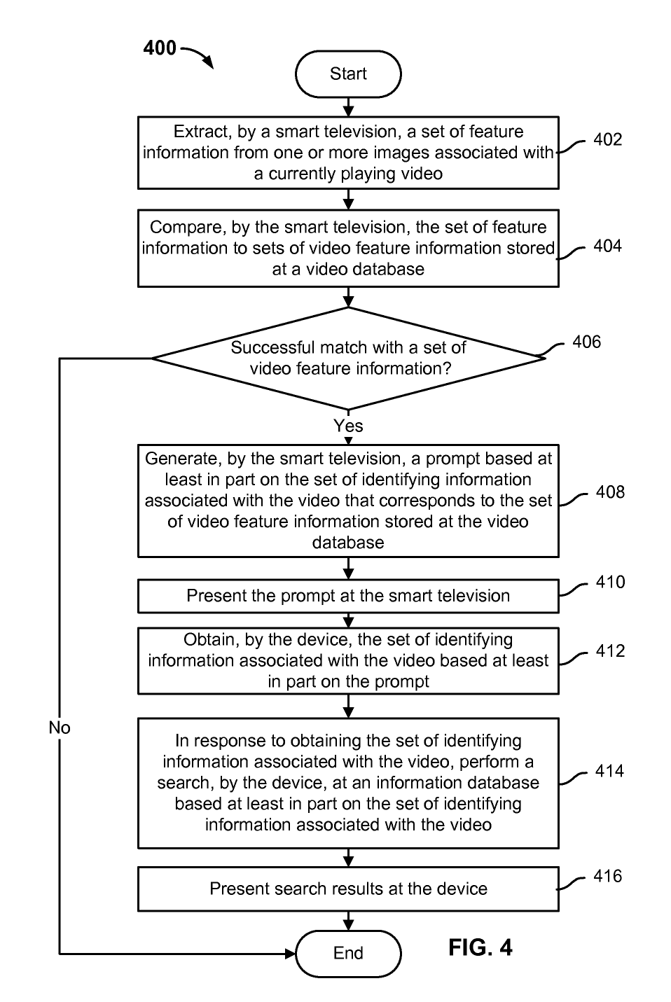

FIG. 4 is a flow diagram showing an example of a process for presenting information based on a video. In some embodiments, process 400 is implemented at system 100 of FIG. 1. In some embodiments, process 200 of FIG. 2 is implemented at least in part by process 400.

Process 400 is implemented by a smart television such as smart television 102 of system 100 of FIG. 1 and also a separate device such as device 104 of system 100 of FIG. 1. In the example of process 400, the device comprises a mobile device that is configured to access the Internet and includes a camera function. Examples of a mobile device include a smart phone, a tablet device, or any other computing device.

At 402, a set of feature information is extracted by a smart television from one or more images associated with a currently playing video.

In various embodiments, the video is currently playing at the smart television.

At 404, the set of feature information is compared by the smart television to sets of video feature information stored at a video database.

The set of feature information that is extracted from the video frames is compared to the sets of video feature information stored at a video database. It is determined whether the set of feature information matches any set of video feature information that is stored at the video database. In some embodiments, the video database is associated with a cloud server.

At 406, it is determined by the smart television whether the set of feature information has successfully matched a set of video feature information stored at the video database, wherein the set of video feature information corresponds to a set of identifying information associated with a video. In the event that a set of video feature information stored at the video database has been determined to successfully match the set of feature information extracted from the video frames, control is transferred to 408. Otherwise, in the event that a set of video feature information stored at the video database has not been determined to successfully match the set of feature information extracted from the video frames, process 400 ends.

At 408, a prompt is generated by the smart television based at least in part on the set of identifying information associated with the video that corresponds to the set of video feature information stored at the video database.

For example, the prompt is displayed on the smart television. The prompt can appear in the form of text, numbers, pictures, or a combination thereof on the smart television screen. For example, the prompt comprises a QR code.

At 410, the prompt is presented at the smart television.

After the user observes the prompt, he or she may use a device that is separate from the smart television to capture the prompt. In process 400, the device may comprise a mobile device that is configured to access the Internet and includes a camera function.

At 412, the set of identifying information associated with the video is obtained by a device based at least in part on the prompt.

For example, if the prompt comprises a QR code, the device can obtain the set of identifying information associated with the video by taking a photo of and/or making a scan of the QR code displayed at the smart television screen.

At 414, in response to obtaining the set of identifying information associated with the video, a search is performed by the device at an information database based at least in part on the set of identifying information associated with the video.

An application executing at the mobile device can read the scanned QR code and determine the set of identifying information associated with the video. Furthermore, the application executing at the mobile device can also perform a search using the set of identifying information associated with the video at an information database. In some embodiments, the information database is associated with a cloud server.

At 416, search results are presented at the device.

The search results obtained by the mobile device can be displayed at a screen of the device itself. If the user is interested in the displayed merchandise information, he or she can use the device to further interact with the merchandise information, such as by requesting more information on a product, purchasing a product, and/or adding a product to a shopping cart. In some embodiments, the user may respond to this prompt by using a mobile device to capture the information associated with the prompt information. For example, prompt information can be displayed in the form of a QR code and the user may select the prompt by scanning the QR code with a mobile device with a scanning or camera function. In response to scanning this QR code, an application executing at the mobile device that is configured to read QR codes may use the content of the QR code (the set of identifying information associated with the video) to perform a search at the advertising information database and display search results at the display screen of the mobile device. The user may select a search result that is displayed at the display screen of the mobile device via a touchscreen or other input mechanism of the mobile device. The user may be prompted by the smart television to log into his or account at a shopping platform associated with at least some products of the presented search results. After the user has logged into his or her account associated with the shopping platform, in some embodiments, the user may select one or more search results presented at the mobile device via an input mechanism of the mobile device to add the products associated with the search results into a shopping cart associated with the user's account at the shopping platform. The user may follow through with purchasing the products in the shopping cart associated with his or her account at the shopping platform at a later time (e.g., using the mobile device or desktop device). After the user has logged into his or her account associated with the shopping platform, in some embodiments, the user may select one or more search results presented at the mobile device via an input mechanism of the mobile device to directly purchase the products associated with the search results. The user may directly purchase the products by inputting his or her credit card information through one or more purchase interfaces presented at the mobile device.

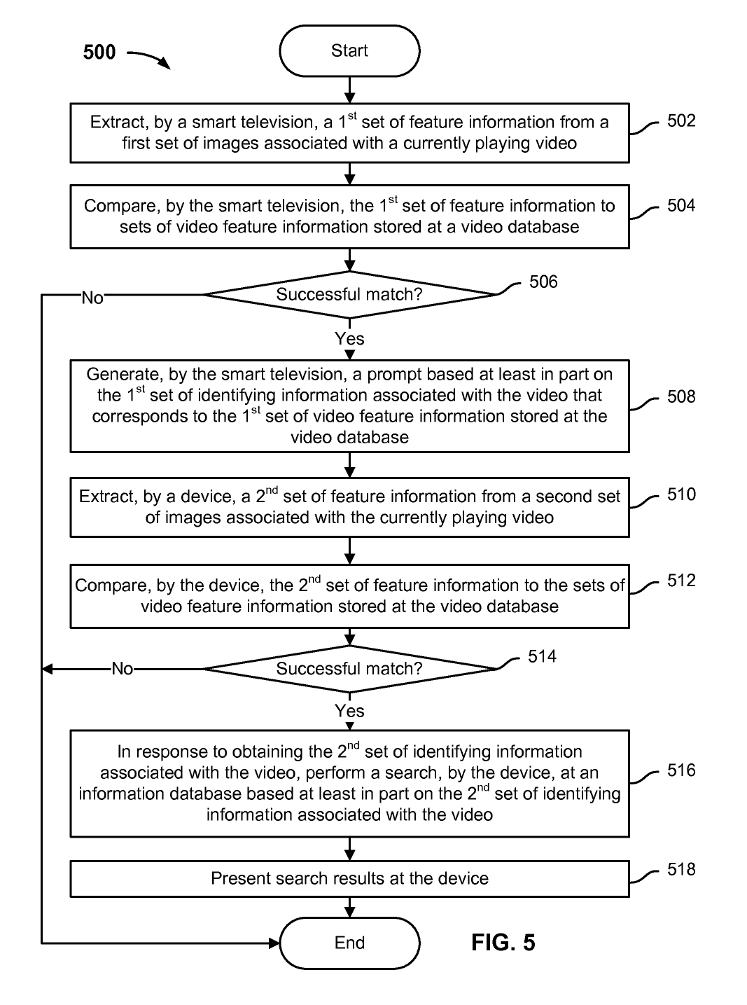

FIG. 5 is a flow diagram showing an example of a process for presenting information based on a video. In some embodiments, process 500 is implemented at system 100 of FIG. 1. In some embodiments, process 200 of FIG. 2 is implemented at least in part by process 500.

Process 500 is implemented by a smart television such as smart television 102 of system 100 of FIG. 1 and also a separate device such as device 104 of system 100 of FIG. 1. In the example of process 500, the device comprises a mobile device that is configured to access the Internet and includes a camera function. Examples of a mobile device include a smart phone, a tablet device, or any other computing device.

In process 500, after a first set of feature information extracted by the smart television from a first set of video frames is determined to match a set of video feature information stored in the video database, the device performs its own extraction of a second set of feature information from a second set of video frames and performs its own comparison of the second set of feature information with sets of video feature information stored at the video database.

At 502, a first set of feature information is extracted by a smart television from a first set of images associated with a currently playing video.

In various embodiments, the video is currently playing at the smart television.

At 504, the first set of feature information is compared by the smart television to sets of video feature information stored at a video database. The set of feature information that is extracted by the smart television from the video frames captured by the smart television is compared to the sets of video feature information stored at a video database. It is determined whether the set of feature information extracted by the smart television matches any set of video feature information that is stored at the video database. In some embodiments, the video database is associated with a cloud server.

At 506, it is determined by the smart television whether the first set of feature information has successfully matched a first set of video feature information stored at the video database, wherein the set of video feature information corresponds to a first set of identifying information associated with a video. In the event that a set of video feature information stored at the video database has been determined to successfully match the set of feature information extracted by the smart television from the video frames captured by the smart television, control is transferred to 508. Otherwise, in the event that a set of video feature information stored at the video database has not been determined to successfully match the set of feature information extracted by the smart television from the video frames captured by the smart television, process 500 ends.

At 508, a prompt is generated by the smart television based at least in part on the first set of identifying information associated with the video that corresponds to the first set of video feature information stored at the video database.

For example, the prompt is displayed on the smart television. The prompt can appear in the form of text, numbers, pictures, or a combination thereof on the smart television screen.

At 510, a second set of feature information is extracted by a device from a second set of images associated with the currently playing video.

After the user observes the prompt, he or she may use a device that is separate from the smart television to capture the prompt and/or the currently playing video. In process 500, the device may comprise a mobile device that is configured to access the Internet and includes a camera function.

For example, the prompt comprises a set of instructions that instructs the user to take a photo or video of the video that is currently playing at the smart television. Then the mobile device that is separate from the smart television is configured to extract its own set of feature information from the frames of the currently playing video that were captured by the mobile device itself. For example, the one or more frames of the video that were captured by the mobile device may differ from the one or more frames of the video that were captured earlier by the smart television because the mobile device may have captured its frames at a later point in the playback of the video than the smart television. As a result, the set of feature information extracted by the mobile device from the video frames that the mobile device captured may differ from the set of feature information extracted by the smart television from the video frames that the smart television had captured.

At 512, the second set of feature information is compared by the device to the sets of video feature information stored at the video database.

The set of feature information that is extracted by the mobile device from the video frames captured by the mobile device is compared to the sets of video feature information stored at the video database. In some embodiments, the video database used in the comparison by the mobile device is the same video database that was used in the comparison by the smart television. It is determined whether the set of feature information extracted by the mobile device matches any set of video feature information that is stored at the video database. In some embodiments, the video database is associated with a cloud server.

At 514, it is determined by the device whether the second set of feature information has successfully matched a second set of video feature information stored at the video database, wherein the second set of video feature information corresponds to a second set of identifying information associated with a video. In the event that a set of video feature information stored at the video database has been determined to successfully match the set of feature information extracted by the mobile device from the video frames captured by the mobile device, control is transferred to 516. Otherwise, in the event that a set of video feature information stored at the video database has not been determined to successfully match the set of feature information extracted by the mobile device from the video frames captured by the mobile device, process 500 ends. In some embodiments, in the event that a set of video feature information stored at the video database has not been determined to successfully match the set of feature information extracted by the mobile device from the video frames captured by the mobile device, instead of process 500 ending, control may be transferred to 502, so that the smart television can again capture a new set of video frames and extract a set of feature information from this new set of video frames.

In some embodiments, while the set of feature information extracted by the smart television differs from the set of feature information extracted by the mobile device, both sets of feature information may be determined to match the same set of video feature information and therefore the same set of identifying information associated with a video that is stored at the video database. In some embodiments, the set of video feature information from the video database that is matched by the set of feature information extracted by the smart television may be different from the set of video feature information from the video database that is matched by the set of feature information extracted by the mobile device, in which case the set of identifying information associated with a video as determined by the smart television would differ from the set of identifying information associated with a video as determined by the mobile device. One reason to have the mobile device extract and compare its own set of feature information from the video currently playing at the smart television after the smart television has extracted and compared its respective set of feature information is that the extraction and/or matching techniques used by the mobile device may be updated and improved more frequently than the extraction and/or matching techniques used by the smart television (e.g., due to the different availability of opportunities to update firmware and software at the smart television and mobile device).

At 516, in response to obtaining the second set of identifying information associated with the video, a search is performed by the device at an information database based at least in part on the second set of identifying information associated with the video.

An application executing at the mobile device can also perform a search using the set of identifying information associated with the video that was determined by the mobile device at the information database.

At 518, search results are presented at the device.

The search results obtained by the mobile device can be displayed at a screen of the device itself. If the user is interested in the displayed merchandise information, he or she can interact with the device to further interact with the merchandise information, such as by requesting more information on a product, purchasing a product, and/or adding a product to a shopping cart. If the feature extraction and/or matching techniques that were used by the mobile device were more precise than those used by the smart television, then the search results returned by the device based on its own determined set of identifying information associated with the video may be more detailed and/or relevant than a different set of identifying information associated with the video that may have been determined by the smart television.

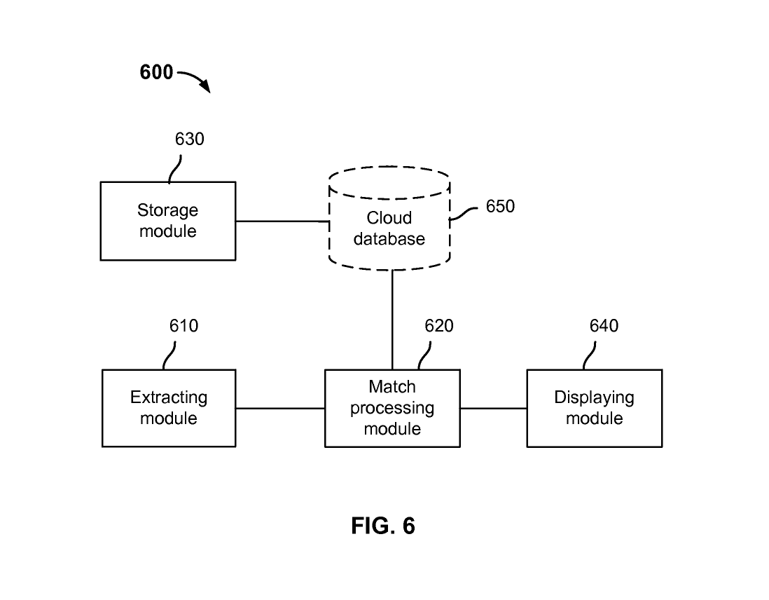

FIG. 6 is a diagram showing an embodiment of a system for presenting information based on a video. In the example, system 600 includes storage module 630, cloud database 650, extracting module 610, match processing module 620, and displaying module 640. In some embodiments, system 600 is associated with and/or a part of a smart television.

The modules can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Extracting module 610 is configured to extract a set of feature information from a currently playing video. In some embodiments, the set of feature information may include audio feature information, video feature information, or audio and video feature information.

Match processing module 620 is connected to extracting module 610 and is configured to compare the set of feature information to sets of video feature information stored at cloud database 650. If a matching set of video feature information can be found in cloud database 650, then match processing module 620 is configured to generate a prompt based on a set of identifying information associated with a video corresponding to the matching set of video feature information. In some embodiments, the set of identifying information associated with the video is also stored at cloud database 650.

Displaying module 640 is for displaying the prompts generated by match processing module 620.

Storage module 630 is configured to store (e.g., cache) at least some of the sets of video feature information and respective corresponding sets of identifying information that were previously obtained from cloud database 650.

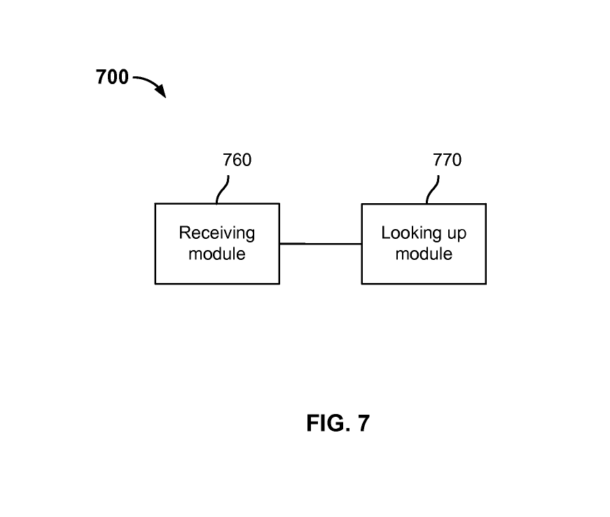

FIG. 7 is a diagram showing an embodiment of a system for presenting information based on a video. In some embodiments, system 700 includes system 600 of FIG. 6. The modules of system 600 of FIG. 6 are not shown again in the diagram of FIG. 7. System 700 also includes receiving module 760 and looking up module 770. In some embodiments, system 700 is associated with and/or a part of a smart television

Receiving module 760 is configured to receive a selection from a device in response to a presentation of a prompt. In some embodiments, the device comprises a remote control device.

Searching module 770 is configured to search at an information database (e.g., that is part of cloud database 650 of system 600 of FIG. 6) for search results that match the set of identifying information associated with the video. For example, the search results can be displayed (e.g., that is part of displaying module 640 of system 600 of FIG. 6). In some embodiments, searching module 770 is configured to present a login user interface associated with a shopping platform. For example, searching module 770 is configured to receive login credentials (e.g., username and password) input by a user (e.g., using a device) and send the login credentials to a server associated with the shopping platform. In some embodiments, searching module 770 is configured to receive a selection of a displayed search result. In response to receiving the selection of the displayed search result, in some embodiments, searching module 770 is configured to send an indication to the server associated with the shopping platform to add a product associated with the selected search result in a shopping cart associated with the user's logged in account at the shopping platform. In response to receiving the selection of the displayed search result, in some embodiments, searching module 770 is configured to present a payment information receiving interface associated with the shopping platform. For example, searching module 770 is configured to receive payment information (e.g., credit card information) input by a user (e.g., using a device) and send the payment information to the server associated with the shopping platform to complete the purchase of the product associated with the selected search result. In response to receiving the selection of the displayed search result, in some embodiments, searching module 770 is configured to present additional information associated with a product associated with the selected search result.

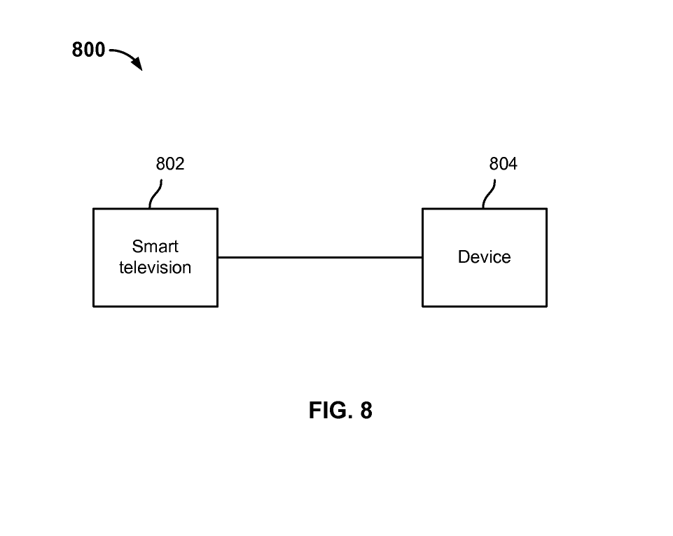

FIG. 8 is a diagram showing an embodiment of a system for presenting information based on a video. In some embodiments, system 800 includes smart television 802 and device 804.

In some embodiments, smart television 802 can be implemented using system 600 of FIG. 6 or system 700 of FIG. 7 and will not be described further.

Device 804 is configured to obtain a set of identifying information associated with a video that was determined by smart television 802 based on a prompt presented by smart television 802. Device 804 is configured to search in an information database (e.g., that is part of cloud database 650 of system 600 of FIG. 6) for information based on the set of identifying information and also display the found search results. In various embodiments, device 804 is capable of accessing the Internet and also includes a camera function. In some embodiments, after smart television 802 presents the prompt, device 804 is configured to capture a set of images from the video currently playing at smart television 802, extract a set of feature information from that set of images, determine a set of identifying information associated with a video based at least in part on comparing that set of feature information to sets of video feature information stored at a video database (e.g., that is part of cloud database 650 of system 600 of FIG. 6), and then perform a search at the information database based on that set of identifying information. In some embodiments, device 804 is configured to present the found search results at screen associated with the mobile device. In some embodiments, device 804 is configured to present a login user interface associated with a shopping platform. For example, device 804 is configured to receive login credentials (e.g., username and password) input by a user (e.g., using a device) and send the login credentials to a server associated with the shopping platform. In some embodiments, device 804 is configured to receive a selection of a displayed search result. In response to receiving the selection of the displayed search result, in some embodiments, device 804 is configured to send an indication to the server associated with the shopping platform to add a product associated with the selected search result in a shopping cart associated with the user's logged in account at the shopping platform. In response to receiving the selection of the displayed search result, in some embodiments, device 804 is configured to present a payment information receiving interface associated with the shopping platform. For example, device 804 is configured to receive payment information (e.g., credit card information) input by a user (e.g., using a device) and send the payment information to the server associated with the shopping platform to complete the purchase of the product associated with the selected search result. In response to receiving the selection of the displayed search result, in some embodiments, device 804 is configured to present additional information associated with a product associated with the selected search result.

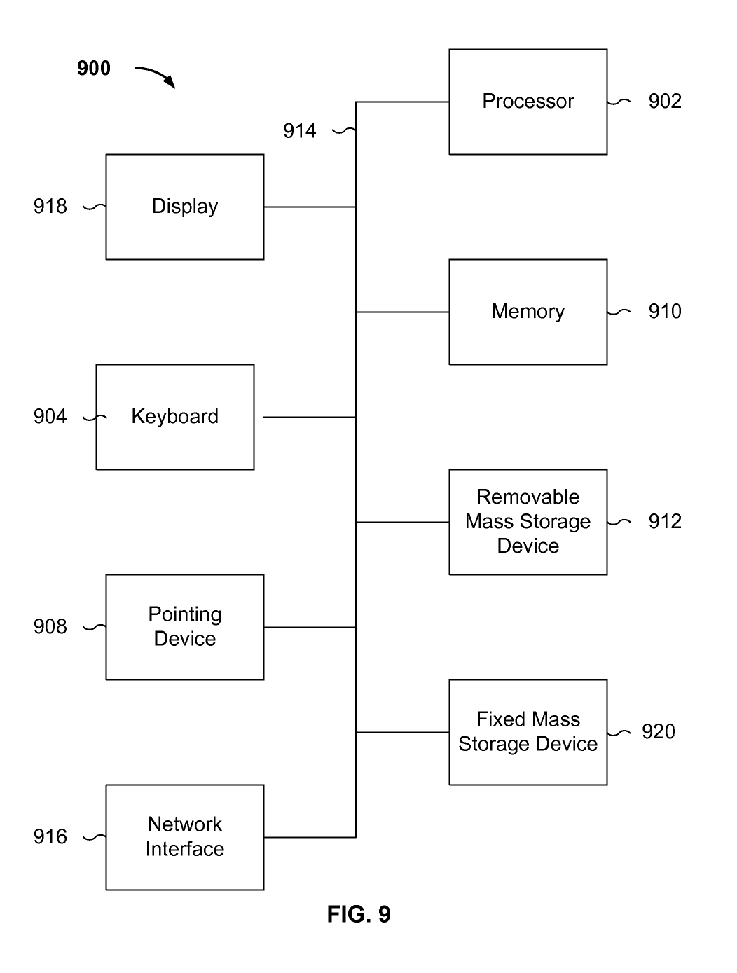

FIG. 9 is a functional diagram illustrating an embodiment of a programmed computer system for implementing presenting information based on a video. As will be apparent, other computer system architectures and configurations can be used to present information based on a video. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In some embodiments, processor 902 includes and/or is used to provide the presentation of information based on a video.

Processor 902 is coupled bi-directionally with memory 910, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data, and objects used by the processor 902 to perform its functions (e.g., programmed instructions). For example, memory 910 can include any suitable computer readable storage media, described below, depending on whether, for example, data access needs to be bi-directional or uni-directional. For example, processor 902 can also directly and very rapidly retrieve and store frequently needed data in a cache memory (not shown).

A removable mass storage device 912 provides additional data storage capacity for the computer system 900 and is coupled either bi-directionally (read/write) or uni-directionally (read only) to processor 902. For example, storage 912 can also include computer readable media such as magnetic tape, flash memory, PC-CARDS, portable mass storage devices, holographic storage devices, and other storage devices. A fixed mass storage 920 can also, for example, provide additional data storage capacity. The most common example of fixed mass storage 920 is a hard disk drive. Mass storage 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display 918, a network interface 916, a keyboard 904, and a pointing device 908, as well as an auxiliary input/output device interface, a sound card, speakers, and other subsystems as needed. For example, the pointing device 908 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

A person skilled in the art should understand that the embodiment of the present application can be provided as methods, systems, or computer program products. Therefore, the present application may take the form of complete hardware embodiments, complete software embodiments, or embodiments that combine software and hardware. In addition, the present application can take the form of computer program products implemented on one or more computer-operable storage media (including but not limited to magnetic disk storage devices, CD-ROMs, and optical storage devices) containing computer operable program codes.

The above-stated are merely embodiments of the present application and do not limit the present application. For persons skilled in the art, the present application may have various modifications and variations. Any modification, equivalent substitution, or improvement made in keeping with the spirit and principles of the present application shall be included within the scope of the claims of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an extractor to extract a set of feature information from one or more images associated with a currently playing video;
a match processor to:
determine that the set of feature information matches a set of video feature information stored at a video database, wherein the set of video feature information corresponds to a set of identifying information associated with a video; and
generate a prompt based at least in part on the set of identifying information associated with the video that corresponds to the set of video feature information stored at the video database;
a display to present the prompt; and
a searcher to, in response to a selection associated with the prompt to receive more information, perform a search at an information database based at least in part on the set of identifying information associated with the video.

2. The system of claim 1, wherein the prompt comprises at least one of text and an image.

3. The system of claim 1, wherein the prompt comprises a Quick Response (QR) code.

4. The system of claim 1, wherein the selection associated with the prompt to receive more information is received from a remote control device.

5. The system of claim 1, wherein the currently playing video is playing at a smart television and wherein the display is further to display search results at the smart television.

6. The system of claim 1, wherein the currently playing video is playing at a smart television and wherein the selection associated with the prompt to receive more information comprises receiving a scan of the prompt at a device.

7. The system of claim 6, wherein the search at the information database is performed by the device and wherein search results are presented at the device.

8. The system of claim 1, wherein the set of feature information comprises a first set of feature information extracted from a first set of images by a smart television, wherein the set of video feature information comprise a first set of video feature information, and wherein a device is further to:
extract a second set of feature information from a second set of images associated with the currently playing video; and
determine that the second set of feature information matches a second set of video feature information stored at the video database, wherein the second set of video feature information corresponds to the set of identifying information associated with the video.

9. The system of claim 1, wherein the display is further to display one or more search results and the searcher is further to:
present a login interface associated with a shopping platform;
receive user credentials via the login interface; and
send the user credentials to a server associated with the shopping platform to access a user account at the shopping platform associated with the user credentials.

10. The system of claim 9, wherein the searcher is further to:
receive a selection associated with a search result of the one or more search results; and
send an indication to a server associated with the shopping platform to add a product associated with the search result to a shopping cart associated with the user account at the shopping platform.

11. The system of claim 9, wherein the searcher is further to:
receive a selection associated with a search result of the one or more search results;
present a payment information receiving interface associated with the shopping platform;
receive payment information via the payment information receiving interface; and
send the payment information to the server associated with the shopping platform to purchase a product associated with the search result.

12. The system of claim 9, wherein the searcher is further to:
receive a selection associated with a search result of the one or more search results; and
present information associated with a product associated with the search result.

13. A method, comprising:
extracting, using one or more processors, a set of feature information from one or more images associated with a currently playing video;
determining that the set of feature information matches a set of video feature information stored at a video database, wherein the set of video feature information corresponds to a set of identifying information associated with a video;
generating a prompt based at least in part on the set of identifying information associated with the video that corresponds to the set of video feature information stored at the video database;
presenting the prompt; and
in response to a selection associated with the prompt to receive more information, performing a search at an information database based at least in part on the set of identifying information associated with the video.

14. The method of claim 13, wherein the prompt comprises at least one of text and an image.

15. The method of claim 13, wherein the prompt comprises a Quick Response (QR) code.

16. The method of claim 13, wherein the selection associated with the prompt to receive more information is received from a remote control device.

17. The method of claim 13, wherein the currently playing video is playing at a smart television and further displaying search results at the smart television.

18. The method of claim 13, wherein the currently playing video is playing at a smart television and wherein the selection associated with the prompt to receive more information comprises receiving a scan of the prompt at a device.

19. The method of claim 18, wherein the search at the information database is performed by the device and wherein search results are presented at the device.

20. The method of claim 13, wherein the set of feature information comprises a first set of feature information extracted from a first set of images by a smart television, wherein the set of video feature information comprise a first set of video feature information, and wherein a device is further to:
extract a second set of feature information from a second set of images associated with the currently playing video; and
determine that the second set of feature information matches a second set of video feature information stored at the video database, wherein the second set of video feature information corresponds to the set of identifying information associated with the video.

21. A computer program product, the computer program product being embodied in a non-transitory computer readable storage medium and comprising computer instructions for:
extracting a set of feature information from one or more images associated with a currently playing video;
determining that the set of feature information matches a set of video feature information stored at a video database, wherein the set of video feature information corresponds to a set of identifying information associated with a video;
generating a prompt based at least in part on the set of identifying information associated with the video that corresponds to the set of video feature information stored at the video database;
presenting the prompt; and
in response to a selection associated with the prompt to receive more information, performing a search at an information database based at least in part on the set of identifying information associated with the video.
